(19) United States
(12) Patent Application Publication
(10) Pub. No.: US 2010/0295504 A1
(43) Pub. Date: Nov. 25, 2010

(54) Vehicle Charger

(76) Inventor: Chu-Geng Lin, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/471,422

(22) Filed: May 25, 2009

(51) Int. Cl. H02J 7/00; H01R 24/00

(52) U.S. Cl. 320/107; 439/660

(57) ABSTRACT

A vehicle charger has a hollow insulating housing which defines an opening at a front wall thereof and a recess at a lateral wall. A printed circuit board is fixedly received in the insulating housing. A positive element is mounted in the insulating housing and electrically connected with the printed circuit board. The positive element has a contact portion which passes through the opening and stretches outside the insulating housing. A negative element assembled in the insulating housing and electrically connected with the printed circuit board has an elastic portion protruding out of the recess partially. A holding frame of U shape has a base portion and two facing connecting arms respectively extending from both ends of the base portion. The connecting arms are pivotally mounted to two substantial opposite portions of the lateral wall biased from the recess.

### BACKGROUND OF THE INVENTION

1. Field of the Invention

The present invention relates to a charger, and more particularly to a vehicle charger adapted for charging electronic devices.

2. The Related Art

Nowadays, a variety of electronic products are broadly used, such as mobile phones, MP3, MP4, and the like. The electronic products require to be charged with electric power after being used for a period of time. But, when people travel by a car or a plane, it is impossible to charge the electronic products in hand. Therefore, vehicle chargers inserted into a socket of the car or the plane for charging the electric power to the electronic product are provided on the market. Generally, the conventional vehicle charger has a housing, a positive element and a negative element disposed at a front of the housing for inserting into the socket of the car or the plane, and a wire extending from a rear of the housing for connecting with the electronic products. In order to extract the vehicle charger conveniently, a protruding portion is formed at a periphery of the rear of the housing. However, as the vehicle charger is miniature, the protruding portion is too small for a user to apply a proper force to the vehicle charger in the process of removing the vehicle charger. It is inconvenient for the user to use.

### SUMMARY OF THE INVENTION

Accordingly, an object of the present invention is to provide a vehicle charger for charging the electronic devices. The vehicle charger has a hollow insulating housing which defines an opening at a front wall thereof and a recess at a lateral wall, adjacent to the front wall. A printed circuit board is fixedly received in the insulating housing. A positive element is mounted in the insulating housing and electrically connected with the printed circuit board. The positive element has a contact portion which passes through the opening and stretches out of the insulating housing. A negative element is assembled in the insulating housing and electrically connected with the printed circuit board. The negative element includes an elastic portion protruding out of the recess partially. A holding frame of U shape has a base portion and two facing connecting arms respectively extending from both ends of the base portion. The connecting arms are pivotally mounted to two substantial opposite portions of the lateral wall biased from the recess.

As described above, the vehicle charger is provided with the holding frame. When a user want to remove the vehicle charger from a socket of a car or a plane, the base portion is held by the user and pulled rearwards. Thus the vehicle charger can be extracted from the socket conveniently and easily. Furthermore, the structure of the holding frame is simple and convenient to manufacture and assemble.

### BRIEF DESCRIPTION OF THE DRAWINGS

The present invention will be apparent to those skilled in the art by reading the following description of a thereof, with reference to the attached drawings, in which:

FIG. 1 is an assembled, perspective view of a vehicle charger of an embodiment in according to the present invention;

FIG. 2 is an exploded, perspective view of the vehicle charger shown in FIG. 1;

FIG. 3 is a perspective view of an upper part of an insulating housing of the vehicle charger shown in FIG. 2 viewed from a bottom angle;

FIG. 4 is an assembled view of the vehicle charger shown in FIG. 2, wherein the upper part of the insulating housing is removed; and

FIG. 5 is a perspective view of the vehicle charger shown in FIG. 1, wherein a holding frame is rotated to engage with a positive element.

### DETAILED DESCRIPTION OF THE EMBODIMENT

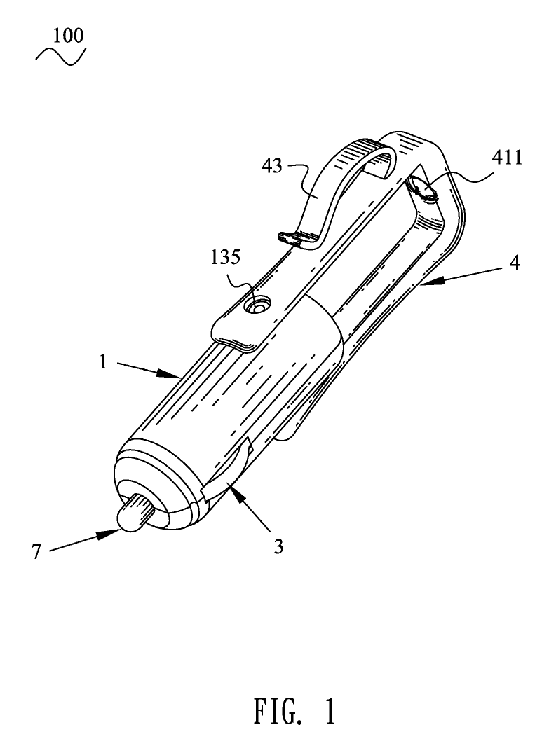

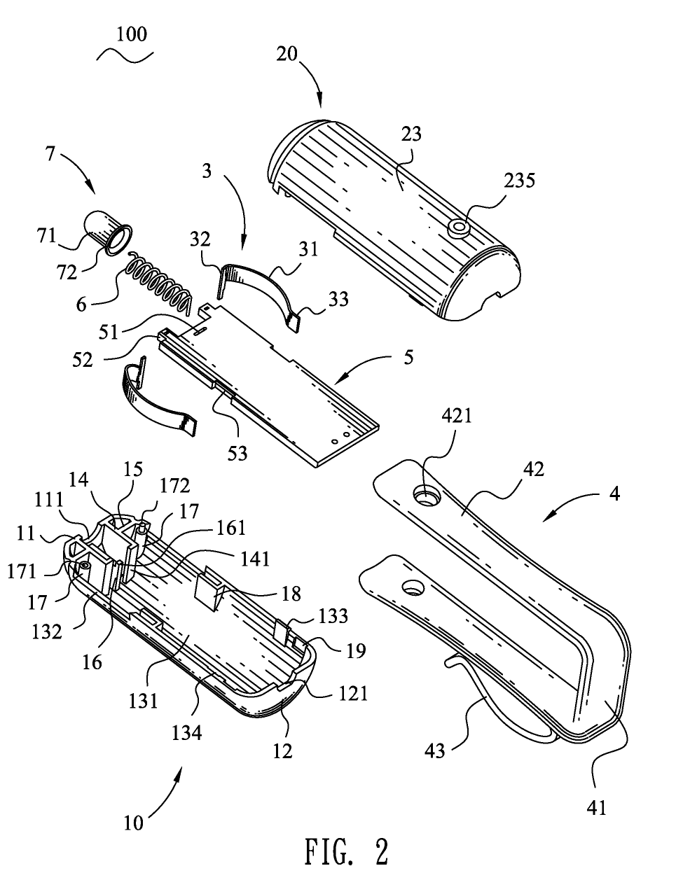

Referring to FIG. 1 and FIG. 2, a vehicle charger 100 in accordance with the present invention includes a hollow insulating housing 1. The insulating housing 1 defines a front wall, a rear wall facing the front wall, and a lateral wall connecting with the front wall and the rear wall. The front wall has a positive element 7 of substantially pillar shape, partially exposing outside thereof. The lateral wall is symmetrically assembled with two negative elements 3, partially exceeding the lateral wall and adjacent to the front wall, and a holding frame 4 of substantially U shape, adjacent to the rear wall. A printed circuit board (PCB) 5 is received in the insulating housing 1 and electrically connected with the positive element 7 and the negative elements 3.

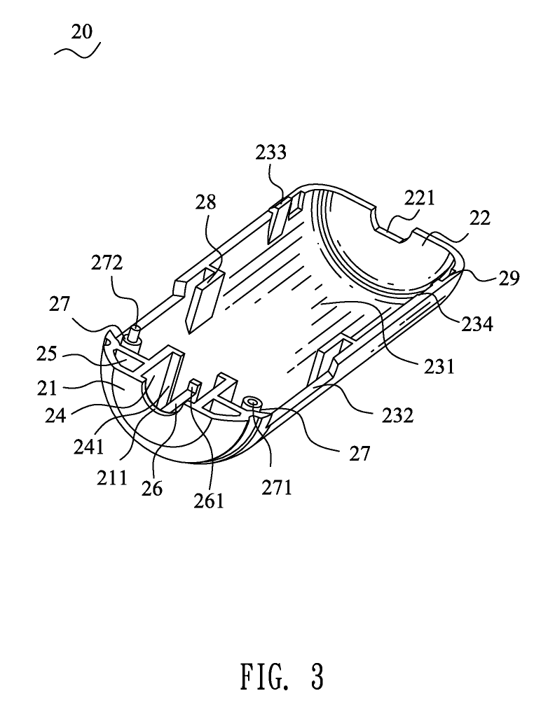

With reference to FIGS. 2-3, the insulating housing 1 is divided into two same parts of U shape viewed from its cross-section, named a lower part 10 and an upper part 20. The lower part 10 defines a front wall 11, a rear wall 12 facing the front wall 11 and a lateral wall 13 connecting with the front wall 11 and the rear wall 12. The front wall 11 is a half-round shape and has an opening 111 at a middle portion of an upper side thereof. The lateral wall 13 defines an inner surface 131 and has two recesses 132 at two opposite upper sides thereof, adjacent to the front wall 11. The inner surface 131 is extended upwards to form two L-shaped stopping walls 14, which face each other and are disposed symmetrically about the opening 111, a supporting wall 16 parallel to and between the stopping walls 14, and two blocking walls 15, each of which intersects with a side of the corresponding stopping wall 14 opposite to the supporting wall 16. The stopping walls 14 are connected with the front wall 11, and have oriented ends 141 away from the opening 111 extending towards and spaced away from each other. The supporting wall 16 is lower than the stopping walls 14 and has a lump 161 at an end of a top edge thereof, between the oriented ends 141 of the stopping walls 14. The blocking wall 15 is perpendicular to the stopping wall 14 and adjacent to a front end of the corresponding recess 132. In this embodiment, top edges of the stopping walls 14 and the blocking walls 15 are flush with a top edge of the front wall 11. Two positioning columns 17 are located adjacent to the corresponding recesses 132 and spaced away from the respective blocking walls 15 with a predetermined distance. In this embodiment, tops of the positioning columns 17 are respectively formed with a hole 171 and a protrusion 172, which are buckled with a protrusion 272 and a hole 271 of the upper part 20 for positioning the assembling position of the upper part 20 with respect to the lower part 10.

The inner surface 131 of the lateral wall 13 has a substantial middle portion extended inwards and bent towards the front wall 11 to form an L-shaped blocking portion 18, with a top edge thereof flush with a top edge of the lateral wall 13. In this embodiment, there are two blocking portions 18 disposed symmetrically and adjacent to rear ends of the respective recesses 132. A wedged lump 133 and a wedged groove 134 are formed at the top edges of the lateral wall 13, adjacent to the rear wall 12, which are coupled with a wedged groove 234 and a wedged lump 233 by using a press fit, for fixing the lower part 10 and the upper part 20 together. The inner surface 131 further has two troughs 19 facing each other and passing through the top edges of the lateral wall 13, between the wedged lump 133 and the rear wall 12, and the wedged groove 134 and the rear wall 12, respectively. The troughs 19 are adapted for receiving indicating lights or other indicating elements for showing the using status of the vehicle charger 100. An outer surface of the lateral wall 13 is protruded downwards to form a fixing portion 135 (see FIG. 1), at a middle portion thereof along a transverse direction of the lower part 10, adjacent to the rear wall 12. As the construction of the upper part 20 is corresponding to that of the lower part 10, the upper part 20 will not be described in detail again.

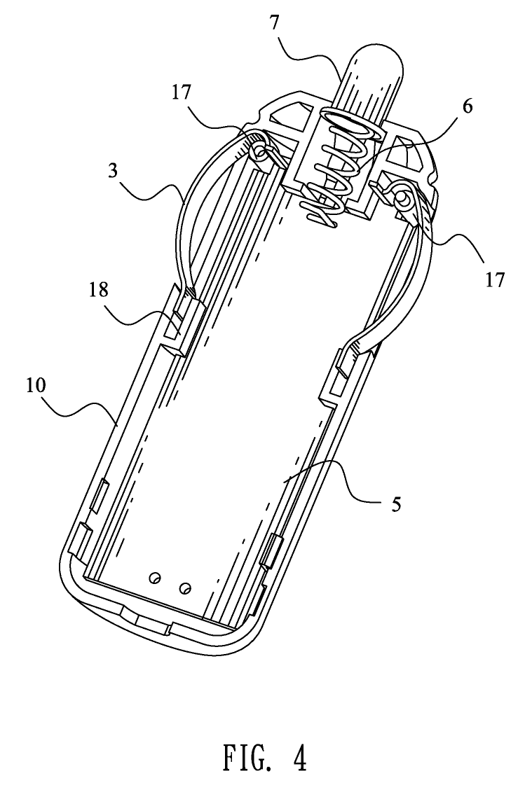

Referring to FIG. 2 and FIG. 4, the positive element 7 is a cap shape and defines a cylindraceous contact portion 71, with one end thereof fabricated to show a dome shape, and a flange 72 wrapping the other end of the contact portion 71. The contact portion 71 passes through the opening 111 and exposes outside the insulating housing 1. The flange 72 is against an edge of the opening 111 for avoiding the positive element 7 separating from the insulating housing 1. The negative element 3 may be formed by punching and bending a metal strip, and defines an elastic portion 31 of arc shape. One end of the elastic portion 31 is enlarged laterally to form a first fixing end 32. The first fixing end 32 is restrained among the stopping wall 14, the blocking wall 15 and the positioning column 17. The other end of the elastic portion 31 is bent back to the first fixing end 32 to form a second fixing end 33. The second fixing end 33 is restrained between the blocking portion 18 and the lateral wall 13. The elastic portion 31 is free and partly exposes outside the insulating housing 1.

The PCB 5, located in the lower part 10, is rectangular and has a slot 51 at a front end thereof, two connecting lumps 52 protruded frontward from a front edge thereof and spaced away from each other, and two notches 53 formed at two opposite sides thereof, preventing from interfering with the blocking portions 18 in assembly. The connecting lumps 52 are respectively located between the stopping walls 14 and positioning columns 17, and contact with the first fixing ends 32. A provided spring 6 is located between the stopping walls 14 and supported by the supporting wall 16, jammed by the oriented ends 141 and the lump 161 for preventing the spring 6 from moving with respect to PCB 5. Two opposite ends of the spring 6 are respectively inserted into the contact portion 71 and slot 51, for electrically connecting with the positive element 7 and the PCB 5. Herein, the rear wall 12 further has a gap 121 for allowing a wire (not shown) to pass therethrough for connecting with the PCB 5 and an outer electronic product (not shown).

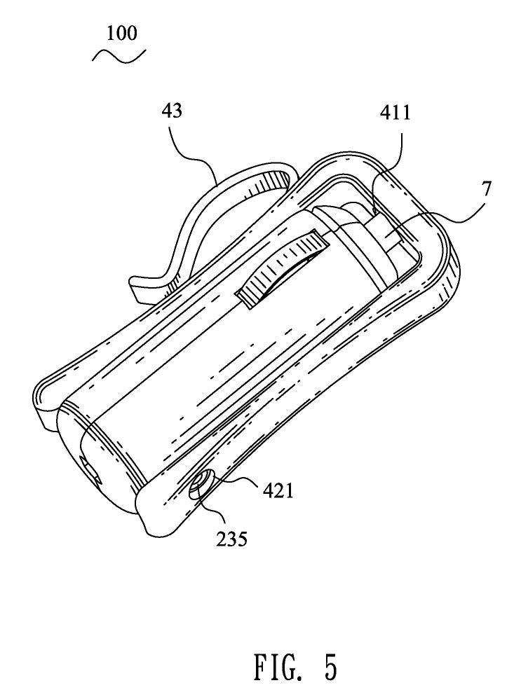

Referring to FIG. 2 and FIG. 5, the holding frame 4 has a base portion 41 and two facing connecting arms 42 perpendicular to the base portion 41. The base portion 41 has a receiving hole 411 at a middle portion of an inner surface thereof. Each of the connecting arms 42 has a fixing hole 421, away from the base portion 41. The fixing holes 421 are pivoted to the fixing portions 135, 235 for fixing the holding frame 4 to the insulating housing 1. In this embodiment, the length of the connecting arms 42 is longer than that of the insulating housing 1, so that the contact portion 71 is resiliently and partially inserted into the receiving hole 411 when the base portion 41 is rotated to be in front of the front wall 11. The holding frame 4 further has an arc elastic clip 43 at outer surface of one of the holding arms 42, for facilitating taking.

When the vehicle charger 100 is in use, the insulating housing 1 is urged to insert into a socket of a car or a plane (not shown). The positive element 7 and the negative elements 3 resiliently contact the socket for charging. When the vehicle charger 100 is required to withdraw from the socket, a user can hold the base portion 41 of the holding frame 4 and pull rearwards to separate the vehicle charger 100 from the socket. Meanwhile, the holding frame 4 can be rotated frontward to make the contact portion 71 be resiliently received into the receiving hole 411, which not only reduces an occupied space of the vehicle charger 100, but also can protect the contact portion 71.

As described above, the structure of the vehicle charger 100 is simple and compact. The holding frame 4 rotatably mounted to the insulating housing 1 is capable of assisting the user to extract the vehicle charger 100 from the socket conveniently and easily. Furthermore, the holding frame 4 can be rotated frontward to make the contact portion 71 be received in the receiving hole 411, which is better to protect the positive element 7 and more convenient for carrying.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A vehicle charger, comprising:
a hollow insulating housing, defining an opening at a front wall thereof and a recess at a lateral wall, adjacent to the front wall;
a printed circuit board, fixedly received in the insulating housing;
a positive element, mounted in the insulating housing and electrically connecting with the printed circuit board, having a contact portion which passes through the opening and stretches out of the insulating housing;
a negative element, assembled in the insulating housing and electrically connecting with the printed circuit board, including an elastic portion protruding out of the recess partially; and
a holding frame of U shape, the holding frame having a base portion and two facing connecting arms respectively extending from both ends of the base portion, two facing connecting arms pivotally mount to two substantial opposite portions of the lateral wall biased from the recess.

2. The vehicle charger as claimed in claim 1, wherein the two facing connecting arms are pivoted to a rear of the lateral wall to make the base portion of the holding frame capable of rotating to be located in front of the front wall for resiliently restricting the contact portion.

3. The vehicle charger as claimed in claim 2, wherein the lateral wall has two portions protruded laterally to form fixing portions for pivotally buckling with fixing holes formed at the respective holding arms and away from the base portion.

4. The vehicle charger as claimed in claim 2, wherein the base portion has a receiving hole at a surface thereof facing the rear wall of the insulating housing, the contact portion is resiliently and partially received in the receiving hole when the base portion is rotated to be in front of the front wall of the insulating housing.

5. The vehicle charger as claimed in claim 1, wherein an inner surface of the lateral wall is protruded inwards to form two L-shaped stopping walls disposed symmetrically about the opening, with oriented ends extending toward each other and away from the opening, and a supporting wall lower than the stopping walls and located between the stopping walls, with a lump formed thereon and between the oriented ends, a spring is placed on the supporting wall and between the stopping walls, jammed by the lump and the oriented ends.

6. The vehicle charger as claimed in claim 5, wherein the positive element has the hollow contact portion, with one end shaped as a dome, and a flange enclosing the other end of the contact portion and against an inner surface of the front wall, one end of the spring is inserted into the contact portion, the other end of the spring is inserted into a slot formed on the printed circuit board.

7. The vehicle charger as claimed in claim 5, wherein the inner surface of the lateral wall has a blocking wall adjacent to the recess and intersecting with the stopping wall, a positioning column is located adjacent to a front end of the recess and spaced from the blocking wall and the stopping wall with a predetermined distance.

8. The vehicle charger as claimed in claim 7, wherein the elastic portion is bent to show an arc shape, one end of the elastic portion is enlarged laterally and restrained among the blocking wall, the stopping wall and the positioning column.

9. The vehicle charger as claimed in claim 8, wherein the inner surface of the lateral wall has a portion adjacent to a rear end of the recess projected inwards and bent towards the front wall to form an L-shaped blocking portion, the other end of the elastic portion is bent to insert between the blocking portion and the lateral wall.

10. The vehicle charger as claimed in claim 7, wherein the insulating housing is divided into two same parts along a front-rear direction, the positioning column of one part is formed with a hole at a top thereof to mate with a protrusion formed on a top of the facing positioning column of the other part for convenient assembly.

11. The vehicle charger as claimed in claim 10, wherein the two parts have two separated lateral walls, which respectively have a wedged lump and a wedged groove at facing edges thereof for fixing the two parts together by a press fit.
